(19) United States
(12) Patent Application Publication
(10) Pub. No.: US 2023/0368531 A1
(43) Pub. Date: Nov. 16, 2023

(54) COMPUTERIZED SYSTEM AND METHOD FOR KEY EVENT DETECTION USING DENSE DETECTION ANCHORS

(71) Applicant: YAHOO ASSETS LLC, Dulles, VA (US)

(72) Inventors: Joao SOARES, New York, NY (US); Avijit SHAH, Santa Clara, CA (US); Topojoy BISWAS, San Jose, CA (US)

(21) Appl. No.: 17/744,343

(22) Filed: May 13, 2022

(51) Int. Cl. G06V 20/40; G06V 10/776; G06V 10/77

(52) U.S. Cl. CPC G06V 20/44; G06V 20/46; G06V 20/41; G06V 10/776; G06V 10/7715

(57) ABSTRACT

According to disclosed embodiments, an event detection framework is provided to detect key events or actions on videos. According to some embodiments, a method is provided to detect an event using the event detection framework by retrieving a frame sequence depicting an event, the frame sequence having a plurality of frames; extracting a feature from each frame of the plurality of frames; combining the extracted features to generate an input matrix; applying an event detection model the input matrix to generate an output matrix; and, determining, based on the output matrix, the event depicted by the frame sequence.

This application includes material that is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE DISCLOSURE

The present disclosure relates generally to improving the performance of network-based content hosting and delivery by modifying the capabilities of and providing non-native functionality to devices, systems and/or platforms in a network through a novel and improved framework for event detection and recognition with precise temporal localization.

### BACKGROUND

Fine-grained event recognition from content within videos depicting sports or performance events remains a computationally intensive task yielding imprecise event recognition. One significant shortcoming of current event recognition approaches is the inability to provide precise temporal localization. While temporal localization errors may be acceptable when determining main events within longer videos, there are a variety of applications where they become unacceptable and higher temporal precision and detection confidence is required. Examples include when detecting scoring events in faster-paced sports, such as basketball and volleyball, as well as detecting frequent short events within slower sports such as soccer (e.g., ball out of play, throw-in, passes, and challenges).

Generally, key event detection or action spotting techniques attempt to detect a single time instant relevant to or indicative of an event in a video. Prior work in the art using temporal regression has been limited to predicting, at most, one event per frame sequence (e.g., video chunk) using a max-pooling operation over the whole temporal dimension. This approach is not well suited for predicting multiple nearby actions. Other techniques in the art attempt to produce a fixed number of possible action predictions per video chunk, each of which may correspond to any time instant within the chunk, and belong to any class. However, this approach faces a challenging machine learning problem during training: simultaneously assigning all of its predictions to time instants and classes such that, in the aggregate, they cover all existing actions within the chunk—thereby requiring a complex model and training procedure, while still performing poorly in terms of precision and recall on standard benchmarks. Such techniques increase the computational and power requirements needed for event detection.

### SUMMARY

This disclosure provides a novel framework that alleviates shortcomings in the art, and provides mechanisms for performing cost-effective, accurate and scalable detection and recognition of relevant events (or actions, used interchangeably) in videos. In some embodiments, key events are relevant occurrences in a sporting event, artistic performance, or live event (i.e., a domain) that may be broadcast or streamed. In some embodiments, event detection as described herein may be applied in the context of sporting events, musical performances, broadcast radio and television, film, and the like. For example, in some embodiments, a key event (or type of key event) may be a touchdown, a tackle, a goal, a musician's solo, or an overtake maneuver in a racing event. In some embodiments, the events can be specific to a player (or actor or person or thing, used interchangeably), a league, type of event, team being represented (e.g., an affiliation), and the like, or combinations thereof.

According to disclosed embodiments, the framework sidesteps the challenges in the art by using a dense set of detection anchors where each output anchor can be preassigned to a time instant and class (e.g., an event). As will be noted, in some embodiments, this approach allows for predicting multiple actions per video chunk while using large chunk sizes that provide ample context for prediction. Then, in some embodiments, the framework uses regressed temporal displacements to further finely localize each action in time.

According to disclosed embodiments, as discussed below, the framework functions by predicting outputs for a dense set of detection anchors, one anchor for every pair formed by a time instant and key event class in a video or sequence of frames. In some embodiments, for each anchor, a detection confidence and a fine-grained temporal displacement is determined. In some embodiments, the framework includes an event detection model. In some embodiments, the event detection model may include a model trunk. In some embodiments, the model trunk may be a one dimensional embodiment of a U-Net. In some embodiments, the model trunk may be a transformer encoder. In some embodiments, the event detection model provides for large temporal contexts important for key event spotting, while also preserving the smaller-scale features required for precise localization. According to some embodiments, event detection models discussed herein are trained using a Sharpness-Aware Minimization (SAM) technique.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 depicts a schematic diagram illustrating an example of a network within which the systems and methods disclosed herein could be implemented according to some embodiments of the present disclosure;

FIG. 2 depicts a schematic diagram illustrating an example of client device in accordance with some embodiments of the present disclosure;

FIG. 3 is a block diagram illustrating components of an exemplary system in accordance with embodiments of the present disclosure;

FIG. 4 illustrates a block diagram of an event detection framework in accordance with some embodiments of the present disclosure;

FIG. 5 illustrates a flow diagram of an exemplary process for event detection according to some embodiments of the present disclosure; and

FIG. 6 illustrates a graph depicting a non-limiting example of target output predictions for a set of dense detection anchors for a given class, according to some embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations thereof, can be implemented by means of analog or digital hardware and computer program instructions. These computer program instructions can be provided to a processor of a general-purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

The detailed description provided herein is not intended as an extensive or detailed discussion of known concepts, and as such, details that are known generally to those of ordinary skill in the relevant art may have been omitted or may be handled in summary fashion.

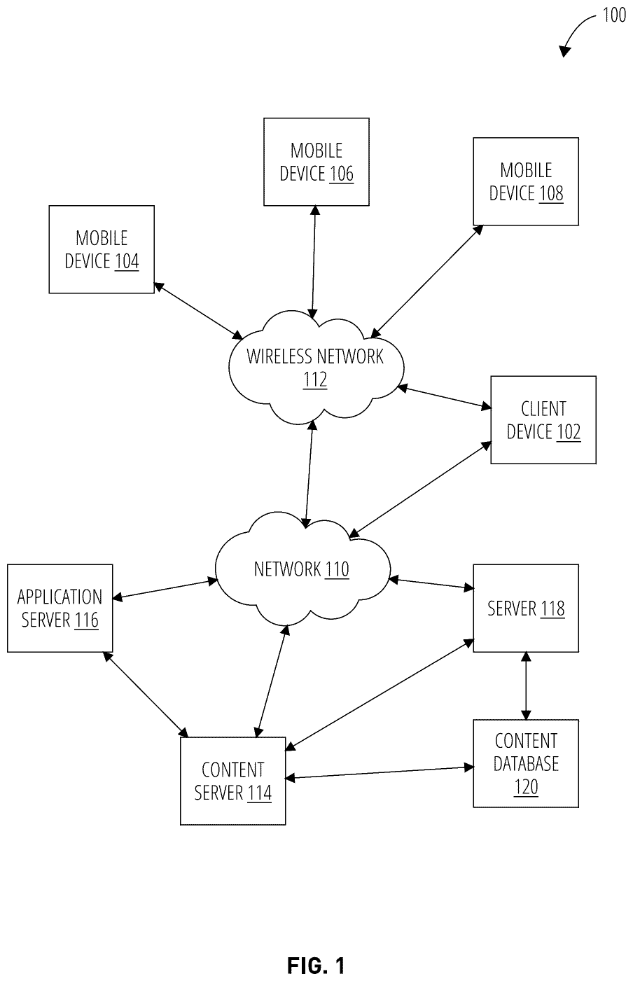

In general, with reference to FIG. 1, a system 100 in accordance with an embodiment of the present disclosure is shown. FIG. 1 shows components of a general environment in which the systems and methods discussed herein may be practiced. Not all the components may be required to practice the disclosure, and variations in the arrangement and type of the components may be made without departing from the spirit or scope of the disclosure. As shown, system 100 of FIG. 1 includes local area networks (“LANs”)/wide area networks (“WANs”)—network 110, wireless network 112, mobile devices (client device) 104-108 and client device 102. FIG. 1 additionally includes a variety of servers, such as content server 114, application (“App”) server 116, and third party servers 118.

One embodiment of mobile devices 104-108 is described in more detail below. Generally, however, mobile devices 104-108 may include virtually any portable computing device capable of receiving and sending a message over a network, such as network 110, wireless network 112, or the like. Mobile devices 104-108 may also be described generally as client devices that are configured to be portable.

Mobile devices 104-108 also may include at least one client application that is configured to receive content from another computing device. The client application may include a capability to provide and receive textual content, graphical content, audio content, and the like. The client application may further provide information that identifies itself, including a type, capability, name, and the like. In one embodiment, mobile devices 104-108 may uniquely identify themselves through any of a variety of mechanisms, including a phone number, Mobile Identification Number (MIN), an electronic serial number (ESN), or other mobile device identifier.

In some embodiments, mobile devices 104-108 may also communicate with non-mobile client devices, such as client device 102, or the like. Client device 102 may include virtually any computing device capable of communicating over a network to send and receive information.

In some embodiments, devices 102-108 may be referred to as computing devices. Devices 102-108 may be capable of sending or receiving signals, such as via a wired or wireless network, or may be capable of processing or storing signals, such as in memory as physical memory states, and may, therefore, operate as a server. Computing devices may, for example, include portable, non-portable, and wearable devices (e.g., desktop computers, cellular phones, smart watches, and tablets).

Wireless network 112 is configured to couple mobile devices 104-108 and its components with network 110. Wireless network 112 may include any of a variety of wireless sub-networks that may further overlay stand-alone ad-hoc networks, and the like, to provide an infrastructure-oriented connection for mobile devices 104-108. Such sub networks may include mesh networks, Wireless LAN (WLAN) networks, cellular networks, and the like. In some embodiments, a wireless network may include virtually any type of wireless communication mechanism by which signals may be communicated between computing devices.

Network 110 is configured to couple content server 114, App server 116, or the like, with other computing devices, including, client device 102, and through wireless network 112 to mobile devices 104-108. Network 110 is enabled to employ any form of computer readable media or network for communicating information from one electronic device to another. Also, network 110 can include the Internet in addition to local area networks (LANs), wide area networks (WANs), or direct connections. According to some embodiments, a “network” should be understood to refer to a network that may couple devices so that communications may be exchanged (e.g., between a server and a client device) including between wireless devices coupled via a wireless network, for example. A network may also include mass storage or other forms of computer or machine readable media, for example.

In some embodiments, the disclosed networks 110 and/or 112 may comprise a content distribution network(s). A “content delivery network” or “content distribution network” (CDN) generally refers to a distributed content delivery system that comprises a collection of computers or computing devices linked by a network or networks.

The content server 114 may include a device that includes a configuration to provide any type or form of content via a network to another device. Content server 114 can further provide a variety of services that include, but are not limited to, email services, instant messaging (IM) services, streaming and/or downloading media services, search services, photo services, web services, social networking services, news services, third-party services, audio services, video services, or the like. Such services, for example a video application and/or video platform, can be provided via the App server 116, whereby a user is able to utilize such service upon the user being authenticated, verified or identified by the service.

Servers 114, 116, and 118 may be capable of sending or receiving signals, such as via a wired or wireless network, or may be capable of processing or storing signals, such as in memory as physical memory states. According to some embodiments, a “server” should be understood to refer to a service point which provides processing, database, and communication facilities. In some embodiments, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

Devices capable of operating as a server may include, as examples, dedicated rack-mounted servers, desktop computers, laptop computers, set top boxes, integrated devices combining various features, such as two or more features of the foregoing devices, or the like.

In some embodiments, users are able to access services provided by servers 114, 116, and/or 118 via the network 110 and/or wireless network 112 using their various devices 102-108.

In some embodiments, applications, such as, but not limited to, news applications (e.g., Yahoo! Sports®, ESPN®, Huffington Post®, CNN®, and the like), mail applications (e.g., Yahoo! Mail®, Gmail®, and the like), streaming video applications (e.g., YouTube®, Netflix®, Hutu®, iTunes®, Amazon Prime®, HBO Go®, and the like), instant messaging applications, blog, photo or social networking applications (e.g., Facebook®, Twitter®, Instagram®, and the like), search applications (e.g., Yahoo!® Search), and the like, can be hosted by the App server 116, or content server 114 and the like.

Thus, the App server 116, for example, can store various types of applications and application related information including application data and user profile information (e.g., identifying and behavioral information associated with a user). It should also be understood that content server 114 can also store various types of data related to the content and services provided by content server 114 in an associated content database 120, as discussed in more detail below. Embodiments exist where the network 110 is also coupled with/connected to a Trusted Search Server (TSS) which can be utilized to render content in accordance with the embodiments discussed herein. Embodiments exist where the TSS functionality can be embodied within servers 114, 116, and/or 118.

Moreover, although FIG. 1 illustrates servers 114, 116, and 118 as single computing devices, respectively, the disclosure is not so limited. For example, one or more functions of servers 114, 116, and/or 118 may be distributed across one or more distinct computing devices. Moreover, in one embodiment, servers 114, 116, and/or 118 may be integrated into a single computing device, without departing from the scope of the present disclosure.

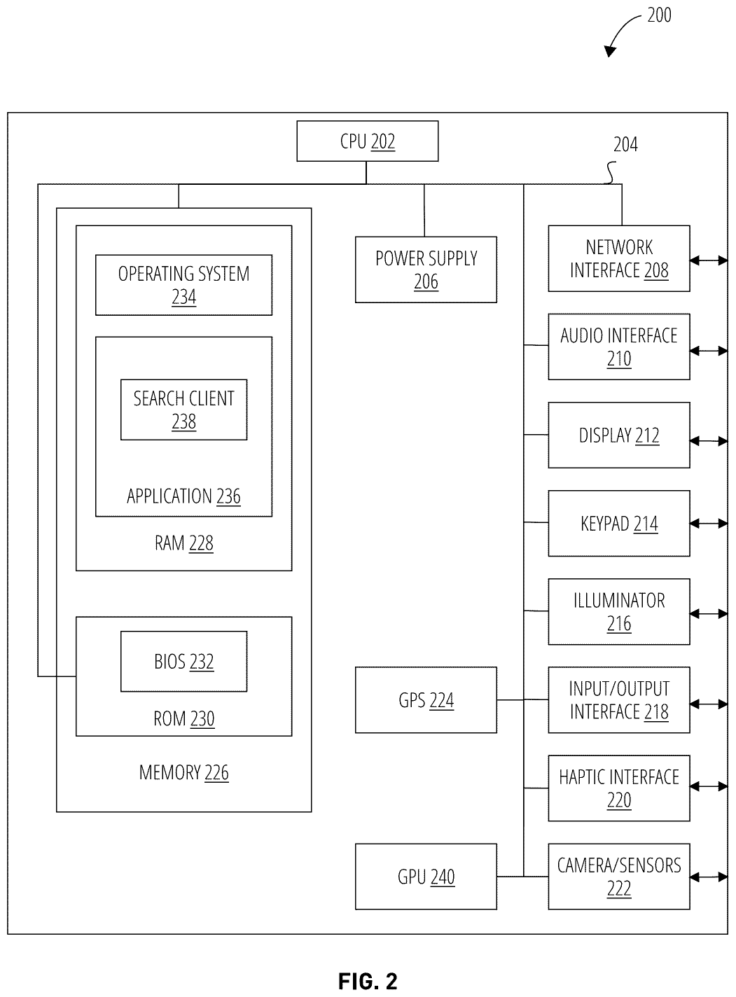

FIG. 2 is a schematic diagram illustrating an example embodiment of a device 200 (e.g., a client device) that may be used within the present disclosure. device 200 may include many more or less components than those shown in FIG. 2. However, the components shown are sufficient to disclose an illustrative embodiment for implementing the present disclosure. Device 200 may represent, for example, devices 118, 114, and/or 116 discussed above in relation to FIG. 1.

As shown in the figure, device 200 includes a processing unit (CPU) 202 in communication with a mass memory 226 via a bus 204. Device 200 also includes a power supply 206, one or more network interface 208, an audio interface 210, a display 212, a keypad 214, an illuminator 216, an input/output interface 218, a haptic interface 220, an optional global positioning systems (GPS) receiver 224 and a camera(s) or other optical, thermal, or electromagnetic sensor 222. Device 200 can include one camera/sensor 222, or a plurality of cameras/sensors 222, as understood by those of skill in the art. Power supply 206 provides power to device 200.

Device 200 may optionally communicate with a base station (not shown), or directly with another computing device. Network interface 208 is sometimes known as a transceiver, transceiving device, or network interface card (NIC).

Mass memory 226 includes a random access memory (RAM) 228, a read-only memory (ROM) 230, and other storage means. Mass memory 226 stores a basic input/output system (BIOS) 232 for controlling low-level operation of device 200. The mass memory 226 also stores an operating system 234 for controlling the operation of device 200.

Mass memory 226 further includes one or more data stores, which can be utilized by device 200 to store, among other things, applications 236 and/or other information or data. For example, data stores may be employed to store information that describes various capabilities of device 200.

Applications 236 may include computer executable instructions which, when executed by device 200, transmit, receive, and/or otherwise process audio, video, images, and enable telecommunication with a server and/or another user of another client device.

Some devices may include additional components, such as graphics processing units (GPU) 240, cryptographic co-processors, artificial intelligence (AI) accelerators and/or engines, or other peripheral devices. In some embodiments, a GPU 240 may be used in place of, or in combination with, a CPU 202. In some embodiments, GPU 240 may be used to train an event detection model. In some embodiments, GPU 240 may be used to implement an event detection model.

Having described the components of the general architecture employed within the disclosed systems and methods, the components' general operation with respect to the disclosed systems and methods will now be described below.

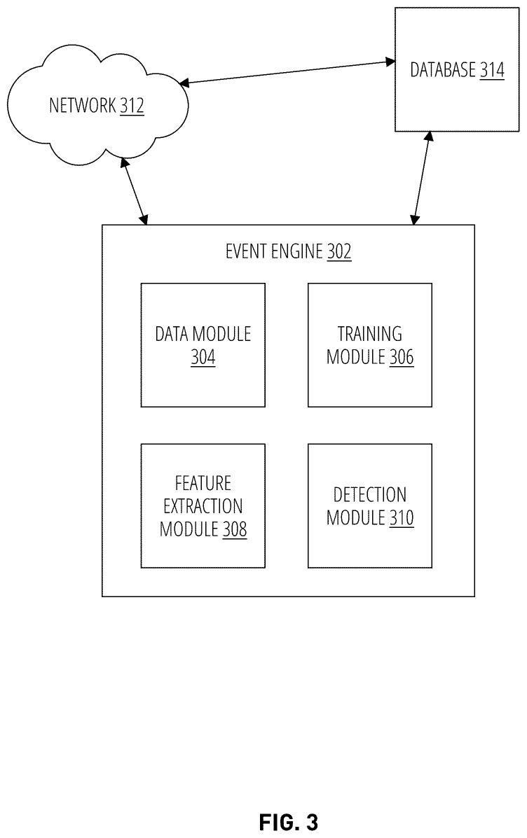

FIG. 3 is a block diagram illustrating the components for performing the systems and methods discussed herein. FIG. 3 includes event engine 302, network 312, and database 314. The event engine 302 can be a special purpose machine or processor and could be hosted by a cloud server (e.g., cloud web services server(s)), messaging server, application server, content server, social networking server, web server, search server, content provider, third party server, user's computing device, and the like, or any combination thereof.

According to some embodiments, event engine 302 can be a stand-alone application that executes on a user device. In some embodiments, event engine 302 can function as an application installed on the user's device, and in some embodiments, such application can be a web-based application accessed by the user device over a network. In some embodiments, portions of the event engine 302 function as an application installed on the user's device and some other portions can be cloud-based or web-based applications accessed by the user's device over a network, where the several portions of the event engine 302 exchange information over the network. In some embodiments, the event engine 302 can be installed as an augmenting script, program or application (e.g., a plug-in or extension) to another application or portable data structure.

The database 314 can be any type of database or memory, and can be associated with a server on a network (e.g., content server 114, App server 116, or server 118) or a user's device (e.g., client device 102-108 from FIG. 1 or device 200 from FIG. 2). Database 314 may comprise a dataset of data and metadata associated with local and/or network information related to users, services, applications, content and the like.

In some embodiments, such information can be stored and indexed in the database 314 independently and/or as a linked or associated dataset. An example of this is a look-up table (LUT). As discussed above, it should be understood that the data (and metadata) in the database 314 can be any type of information and type, whether known or to be known, without departing from the scope of the present disclosure.

According to some embodiments, database 314 can store data for users, e.g., user data. According to some embodiments, the stored user data can include, but is not limited to, information associated with a user's profile, user interests, user behavioral information, user patterns, user attributes, user preferences or settings, user demographic information, user location information, user biographic information, and the like, or some combination thereof. In some embodiments, the user data can also include user device information, including, but not limited to, device identifying information, device capability information, voice/data carrier information, Internet Protocol (IP) address, applications installed or capable of being installed or executed on such device, and/or any, or some combination thereof. It should be understood that the data (and metadata) in the database 314 can be any type of information related to a user, content, a device, an application, a service provider, a content provider, whether known or to be known, without departing from the scope of the present disclosure.

According to some embodiments, database 314 can store data and metadata associated with users, messages, images, videos, text, products, items and services from an assortment of media, applications and/or service providers and/or platforms, and the like. Accordingly, any other type of known or to be known attribute or feature associated with a message, data item, media item, login, logout, website, application, communication (e.g., a message) and/or its transmission over a network, a user and/or content included therein, or some combination thereof, can be saved as part of the data/metadata in database 314.

According to some embodiments, database 314 may include a training dataset including videos or images corresponding to known events. In some embodiments, a training dataset is a dataset used in training a machine learning algorithm or model. In some embodiments, the training dataset includes frames having annotations related to an event depicted by the frame. In some embodiments, the training dataset is created after training (e.g., annotating or labeling) an untrained data set.

As discussed above, with reference to FIG. 1, the network 312 can be any type of network such as, but not limited to, a wireless network, a local area network (LAN), wide area network (WAN), the Internet, or a combination thereof. The network 312 facilitates connectivity of the event engine 302, and the database 314 of stored resources. Indeed, as illustrated in FIG. 3, the event engine 302 and database 314 can be directly connected by any known or to be known method of connecting and/or enabling communication between such devices and resources.

The principal processor, server, or combination of devices that comprise hardware programmed in accordance with the special purpose functions herein is referred to for convenience as event engine 302, and includes data module 304, training module 306, feature extraction module 308, and detection module 310. It should be understood that the engine(s) and modules discussed herein are non-exhaustive, as additional or fewer engines and/or modules (or sub-modules) may be applicable to the embodiments of the systems and methods discussed. The operations, configurations and functionalities of each module, and their role within embodiments of the present disclosure will be discussed below.

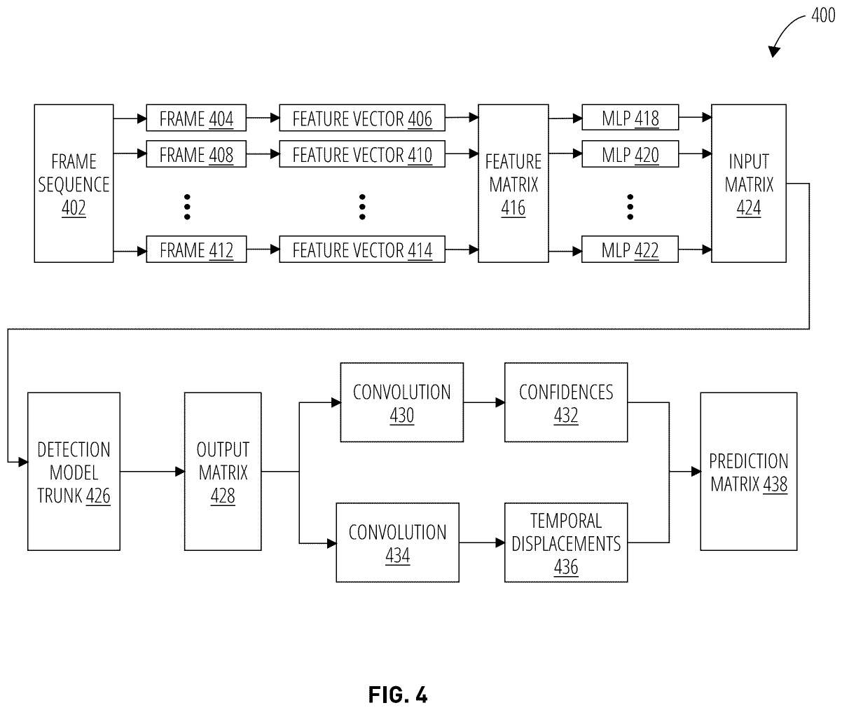

FIG. 4 depicts a non-limiting example embodiment of an event detection framework 400. According to an embodiment, for a given frame sequence 402 (e.g., video) framework 400 determines a prediction matrix including a confidence and a temporal displacement for each frame in the sequence and for each class of a plurality of classes. In some embodiments, each class corresponds to a possible event depicted in the frame sequence. In some embodiments, events or actions are relevant occurrences in a sporting event, artistic performance, or live event that may be broadcast or streamed. For example, an event (or type of event) may be a touchdown, a tackle, a goal, a ball out of play, or a throw-in in a sporting event, a musician's solo in a live musical performance, or an overtake maneuver in a racing event. In some embodiments, the frame sequence may be a domain specific (e.g., corresponding to a specific sport, league, player, broadcaster, and the like) frame sequence with a predetermined set of classes (e.g., events). In some embodiments, a frame sequence 402 can be a snippet or chunk of a longer frame sequence. For example, in an embodiment, frame sequence 402 may be a half second video chunk or snippet of a 2 minute video.

According to some embodiments, framework 400 may be split into two phases—feature extraction (denoted by blocks 402-416) and event detection (denoted by blocks 418-436). As will be noted, this approach significantly decreases the computational burden during training and permits meaningful comparisons across embodiments. In some embodiments, in the first phase, a frame sequence 402 may be decoded into frames 404,408, and 412. Then, feature extraction may be performed on each frame to generate a corresponding feature vector. For example, in some embodiments, a feature extraction model may be applied to frames 404, 408, and 412, to generate feature vectors 406, 410, and 412, respectively. In some embodiments, feature vectors 406, 410, and 412 may be combined (e.g., stacked) to generate feature matrix 416. In some embodiments, feature extraction may be performed using ResNet or 3D convolutions on a frame sequence. In some embodiments, each row of the feature matrix 416 corresponds to a frame of the frame sequence 402. In some embodiments, each column of the feature matrix 416 corresponds to a feature channel of the respective frame. In some embodiments, each column of the feature matrix 416 corresponds to a feature of the respective frame.

In some embodiments, feature vector (e.g., feature vectors 406, 410, and 414) of size P can be generated for each frame T. Then, in some embodiments, a feature matrix (e.g., feature matrix 416) may include a sequence of T feature vectors of dimension P (e.g., a T×P feature matrix). In some embodiments, S feature vectors of size P may be generated for each frame (e.g., a S×P feature matrix per frame), and all feature matrices for all frames may be combined in an TS×P feature matrix to represent a frame sequence.

In some embodiments, feature matrix 416 may be a combination of the feature vectors or matrices corresponding to each frame of the frame sequence 402. In some embodiments, feature matrix 416 represents the whole frame sequence 402.

In some embodiments, instead of generating a feature vector per frame, each feature vector (e.g., feature vectors 406, 410, and 412) may be computed from a block of frames. For example, in some embodiments, a block of frames may be 16 consecutive frames, where each single frame is an image. In some embodiments, the feature vector corresponding to a block of frames may be computed using 3D convolutions (e.g., C3D). In some embodiments, consecutive feature vectors may be computed using overlapping blocks of input frames (e.g., frames from one block are contained in another block).

While some embodiments described herein refer to images, in other embodiments, where audio is analyzed, each feature vector can be based on a small, localized piece of the audio signal. In those embodiments, feature extraction may be performed using audio feature extraction models (e.g., VGGish and AST).

In some embodiments, where a video is analyzed, feature vectors 406, 410, and 412 may be computed from the words in the video's transcript, where each word may be assigned to the moment in time in which it was spoken. Then, in some embodiments, the feature vectors may be stacked to form the feature matrix.

In some embodiments, feature vectors 406, 410, and 412 may be created by concatenating feature vectors from different modalities. For example, in some embodiments, visual feature vectors based on a single image frame from a video can be concatenated with an audio-based feature vector corresponding to the same moment in the video.

According to some embodiments, in the second phase, framework 400 uses the feature matrix 416 to detect an event. In some embodiments, a dimensionality reduction technique is applied to feature matrix 416 to generate input matrix 424. In some embodiments, the dimensionality reduction technique may include one or more multilayer perceptron models (e.g., MLP 418-422). In some embodiments, the dimensionality reduction technique may include a 2-layer multilayer perceptron model. In some embodiments, where a feature vector is determined for each frame, MLPs 418-422 may be applied independently to each feature vector and the outputs combined into input matrix 424.

The input matrix 424 is then propagated through detection model trunk 426 to generate output matrix 428. In some embodiments, the model combines information across all temporal locations while maintaining the sequence size T in the output matrix 428.

According to some embodiments, detection model trunk 426 can include a modified version of a U-Net architecture (a “modified U-Net”) focusing on frames over the temporal dimension (as opposed to over two-dimensional spatial dimensions). In some embodiments, the modified U-Net may consist of a contracting path that captures global context, followed by a symmetric expanding path. In some embodiments, the features of the symmetric expanding path can then be combined with those from the contracting path to enable precise localization. In some embodiments, detection model trunk 426 replaces a traditional U-Net's standard 2-D convolution blocks with 1-D versions of ResNet-V2 bottleneck blocks. In some embodiments, the modified U-Net can be trained with Sharpness-Aware Minimization (SAM).

According to some embodiments, detection model trunk 426 can include a Transformer Encoder (TE) architecture. As will be noted, a TE architecture allows each token in a sequence to attend to all other tokens, thus incorporating global context while still preserving important local features. In some embodiments, the TE can be trained with Sharpness-Aware Minimization (SAM).

Then, in some embodiments, output matrix 428 is propagated through two distinct convolution models 430 and 434 to generate confidences 432 and temporal displacements 436, respectively. As will be understood, in some embodiments, convolution operations may be performed by a convolutional neural network having one or more convolution layers. In some embodiments, convolutions 430 and 434 can be represented by Convolution (w,n) which denotes a convolution with kernel size w and with number of convolutional filters n.

According to some embodiments, confidences 432 and temporal displacements 436 can then be combined to generate a prediction matrix 438 indicating a likelihood that the frame sequence 402 depicts a specific event (e.g., a class). In some embodiments, to generate prediction matrix 438 each confidence of the confidences 432 can be displaced by a corresponding temporal displacement of the temporal displacements 436 to keep the maximum confidence when two or more confidences are displaced into the same temporal location. Then, in some embodiments, a non-maximum suppression (NMS) technique may be applied to the displaced confidences. In some embodiments, the NMS technique may be applied to each class separately.

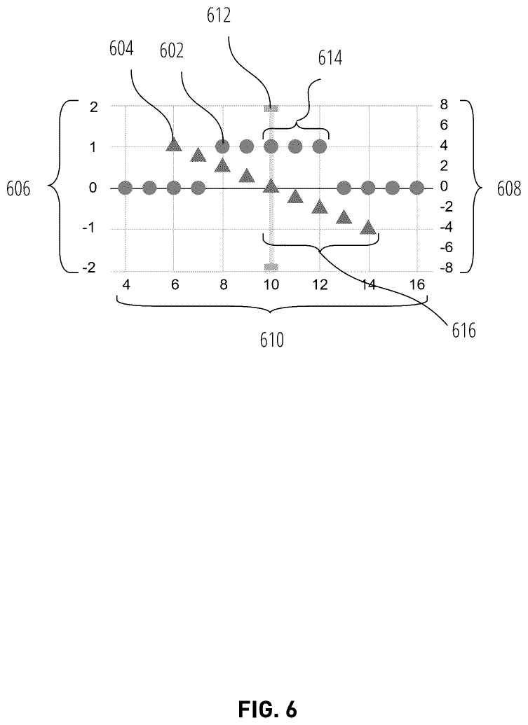

According to some embodiments, to determine which event or events may be depicted by the frame sequence, a class or classes from the prediction matrix 438 can be selected. In some embodiments, prediction matrix 438 includes a dense set of T×K anchors, where K indicates the number of classes. Dense anchors will be discussed in further detail with respect to FIG. 6. In some embodiments, the classes from the prediction matrix 438 are ranked according to the displaced confidences and the classes above a certain threshold of confidence are selected. In some embodiments, the threshold is determined as a percentage of the total number of classes (e.g., top 10%). In some embodiments, the class with the highest confidence is selected.

In some embodiments, a frame sequence 402 may depict one or more events of the same event type. For example, in an embodiment, a frame sequence 402 is 20 seconds long depicting an event of type “pass” at second 4 and another event of type “pass” at second 13. Then, in some embodiments, the resulting prediction matrix of size T×K may have entries at (4,2) and (13,2) where event type “pass” is represented at column k=2. In those embodiments, entries (4,2) and (13,2) may have a value of 1.0 (representing 100% confidence) while the other entries in the prediction matrix may have values of 0.0 (representing 0% confidence).

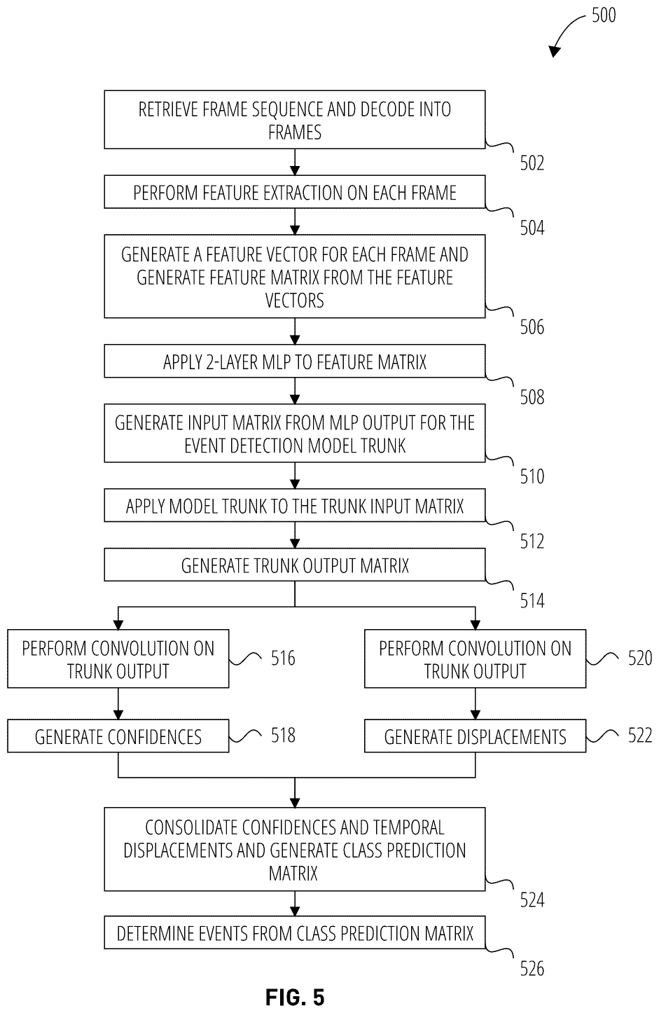

Turning to FIG. 5, FIG. 5 illustrates a flow diagram of a non-limiting Process 500 for event detection according to some embodiments of the present disclosure. As noted elsewhere, according to an embodiment, Process 500 detects a key event or action on a frame sequence using a dense set of detection anchors for every pair formed by a time instant and event class in the sequence of frames. The components of FIG. 3 will be used to discuss the operations of the Steps of Process 500. The steps of Process 500 correspond to the data flow within the framework discussed above in relation to FIG. 4.

Process 500 begins with Step 502 where data module 304 of event engine 302 identifies and retrieves a video (e.g., frame sequence 402) from database 314. In some embodiments, the video is a given video of a corpus of videos. In some embodiments, a single video can be retrieved where the subsequent steps of Process 500 can be applied thereto in a sequence with other videos; and in some embodiments, a plurality of videos can be retrieved as a batch operation, whereby the subsequently disclosed steps of Process 500 are performed in a batch.

For purposes of this disclosure, the processing of a retrieved video from Step 502 will be in regard to a single video solely for clarity of explanation purposes, as one of ordinary skill in the art would readily recognize the applicability of event engine 302's performance of Process 500 to a plurality of videos without departing from the scope of the instant disclosure.

According to some embodiments, in Step 502, the data module 304 may retrieve a full video and select only a portion of the video (e.g., a video chunk). In some embodiments, the video chunk may have a duration of T/f seconds. In some embodiments, data module 304 may further decode the video chunk into frames. In Step 504, the feature extraction module 308 can apply a feature extraction model to each frame of the video chunk and, in Step 506, generate an input feature matrix for each frame. In some embodiments, from each frame sequence, T feature vectors of dimension P may be extracted to generate a T×P input feature matrix (e.g., feature matrix 416). As noted above, in some embodiments, S feature vectors of size P may be generated for each frame (e.g., a S×P feature matrix per frame), and all feature matrices for all frames may be combined in an TS×P feature matrix to represent a frame sequence.

In Step 508, the detection module 310 applies a dimensionality reduction technique to the input feature matrices. In some embodiments, dimensionality reduction is performed using a multi-layer perceptron (MLP) applied independently to each feature vector of the input feature matrix of each frame. As used herein, a MLP is an artificial neural network capable of reducing the dimensionality of a set of input features. However, as will be understood, in Step 508, detection module 310 may use any dimensionality reduction technique known or to be known without departing from the scope of the present disclosure. In some embodiments, the MLP is a two-layer MLP.

In Step 510, the detection module 310 combines the outputs of the dimensionality reduction technique to generate an input matrix for the event detection model trunk. As noted above, the model trunk may be a U-Net as described herein or a TE. And, in Step 512, the detection module 310 propagates the input matrix through the event detection model trunk to generate an output matrix (e.g., output matrix 428) in Step 514.

In some embodiments, in Steps 516 and 520 a convolution operation is performed on the output matrix to generate confidences (e.g., confidences 432) and temporal displacements (e.g., temporal displacements 436) in Steps 518 and 522, respectively. In Step 524, the confidences and temporal displacements are consolidated by displacing the confidences by the temporal displacements. The result of the combination operation is a class prediction matrix (e.g., prediction matrix 438). In some embodiments, the class prediction matrix includes one or more classes corresponding to potential events or actions that may be depicted by the frame sequence retrieved in Step 502.

In Step 526, the detection module 310 determines a likely event from the classes of the class prediction matrix by selecting from the one or more classes. For example, in an embodiment, the detection module 310 may select the class or classes above a predetermined threshold of confidence. In some embodiments, the threshold can be arbitrarily selected. In some embodiments, the threshold can be determined based on a percentage of confidence (e.g., greater than 90%). In some embodiments, the detection module 310 may rank the classes by confidence or other scoring metric and select the class or top few classes with the highest scores.

Turning now to FIG. 6, FIG. 6 illustrates a graph depicting a non-limiting example of targets (e.g., desired predictions) for the dense detection anchors for a given class (e.g., event) according to some embodiments of the present disclosure.

FIG. 6 illustrates confidence axis 606, temporal displacement axis 608, and time axis 610 where time is shown in seconds. FIG. 6 further illustrates, confidences 602 (denoted by c_{*,k}) and temporal displacements 604 (denoted by d_{*,k}) a ground truth event 612 of class k at one anchor per second corresponding to a video chunk. As will be noted, in some embodiments, confidences c_{*,k} and/or temporal displacements d_{*,k} may be referred to as anchors. In some embodiments, confidences 602 and temporal displacements 604 may be confidences 432 and temporal displacements 436, respectively, discussed with respect to FIG. 4. In some embodiments, confidences 602 and temporal displacements 604 may be the result of Steps 518 and 522, respectively, discussed in relation to Process 500. In some embodiments, temporal displacements 604 may be the result of a temporal displacement regression.

According to some embodiments, predicted confidences 602 may be represented by Ĉ=(ĉ_{t,k}) and temporal displacements 604 may be represented by \hat{D}=(\hat{d}_{t,k}), where t=1, 2, . . . , T indexes the T temporal locations of a given video chunk, and k=1, 2, . . . , K indexes the K classes. As noted above, Ĉ and \hat{D} may be the result of respective convolution operations. In some embodiments, the convolution operations may use a temporal window of size 3 while having K output channels.

According to some embodiments, each convolution model (e.g., confidence convolution 430 and temporal displacements convolution 434) may have a corresponding loss—confidence loss L_{C} and temporal displacement loss L_{D}. In some embodiments, during a training process to train the framework 400, each loss may be optimized separately. Still, in some embodiments, the confidence loss L_{C} and the temporal displacement loss L_{D} can be optimized jointly.

According to some embodiments, the confidence loss L_{C} and the temporal displacement loss L_{D} can be calculated with respect to targets (e.g., desired outputs or predicted events as discussed above). In some embodiments, the targets may be derived from N ground-truth actions (e.g., ground truth event 612) contained within a given video chunk or frame sequence. In some embodiments, the ground-truth actions may be denoted as G={(tᵢ,kᵢ)}ᵢ₌₁^{N}.

In some embodiments, the confidence loss L_{C} for a video chunk can be computed with respect to target confidences C=(c_{t,k}), defined to be 1 within an r_{c} seconds radius (e.g., radius 614) of a ground-truth action (e.g., ground truth event 612) and 0 elsewhere. That is:

c_{t,k}=I(∃(s,k)∈G:|s−t|≤r_{c}f)

where I is the indicator function and f is the temporal feature rate (e.g., the number of feature vectors extracted per second).

Then, in some embodiments, the confidence loss L_{C} may be defined as:

$${L}_{c} ( \hat{C} , C ) = {\sum }_{k = 1}^{K} {\sum }_{t = 1}^{T} C E ( {\hat{c}}_{t , k} , {c}_{t , k} )$$

where CE denotes a standard cross-entropy loss. In some embodiments, r_{c} may be in the order of a few seconds (e.g., 1-5 seconds). In some embodiments, r_{c} may be determined by a length of the full video or a video chunk.

In some embodiments, the temporal displacement loss L_{D} may be applied within an r_{d} seconds radius (e.g., radius 616) of a ground-truth action. In some embodiments, temporal displacements 604 may be undefined outside a radius 616 (denoted by r_{d}). For example, in the non-limiting embodiment of FIG. 6, r_{d}=4.

In some embodiments, for each class k a temporal support set is defined as:

S(k)={t=1,2, . . . ,T|∃(s,k)∈G:|s−t|≤r_{d}f}

Then, in some embodiments, the temporal displacement loss L_{D} may be defined as:

$${L}_{d} ( \hat{D} , D ) = {\sum }_{k = 1}^{K} {\sum }_{t ∈ S ( k )} {L}_{h} ( {\hat{d}}_{t , k} , {d}_{t , k} )$$

where Lₕ denotes a Huber regression loss and the targets D=(d_{t,k}) are defined so that each d_{t,k} is the signed difference between t and the temporal index of its nearest ground-truth action of class k in G.

As noted above the several models of an event detection framework (e.g., framework 400) may be trained during a training process using a training dataset (e.g., as discussed in relation to FIG. 3). In some embodiments, an event detection framework may include a dimensionality reduction model (e.g., an MLP), an event detection trunk (e.g., U-Net, TE), and one or more convolution models. According to some embodiments, training of the models may be performed by data module 304 and training module 306 of the event engine 302. According to some embodiments, a training process may use an ADAM optimizer with Sharpness-Aware Minimization (SAM), mixup data augmentation, and decoupled weight decay. As will be noted, generally, SAM seeks wide minima of a loss function.

According to some embodiments, during the training process the temporal displacement regression and the confidence prediction of the event detection framework may be trained separately—resulting in a two-step approach. According to some embodiments, first, during training, one or more of the models of the framework may be trained focusing only on confidences by optimizing the confidence loss L_{C}. In some embodiments, optimizing L_{C} uses mixup data augmentation. Then, in some embodiments, one or more of the models may be trained focusing only on temporal displacements by optimizing L_{D}. In some embodiments, optimizing L_{D} does not use mixup data augmentation.

As utilized herein, the terms “comprises” and “comprising” are intended to be construed as being inclusive, not exclusive. As utilized herein, the terms “exemplary,” “example,” and “illustrative,” are intended to mean “serving as an example, instance, or illustration” and should not be construed as indicating, or not indicating, a preferred or advantageous configuration relative to other configurations. As utilized herein, the terms “about,” “generally,” and “approximately” are intended to cover variations that may exist in the upper and lower limits of the ranges of subjective or objective values, such as variations in properties, parameters, sizes, and dimensions. In one non-limiting example, the terms “about,” “generally,” and “approximately” mean at, or plus 10 percent or less, or minus 10 percent or less. In one non-limiting example, the terms “about,” “generally,” and “approximately” mean sufficiently close to be deemed by one of skill in the art in the relevant field to be included. As utilized herein, the term “substantially” refers to the complete or nearly complete extent or degree of an action, characteristic, property, state, structure, item, or result, as would be appreciated by one of skill in the art. For example, an object that is “substantially” circular would mean that the object is either completely a circle to mathematically determinable limits, or nearly a circle as would be recognized or understood by one of skill in the art. The exact allowable degree of deviation from absolute completeness may in some instances depend on the specific context. However, in general, the nearness of completion will be so as to have the same overall result as if absolute and total completion were achieved or obtained. The use of “substantially” is equally applicable when utilized in a negative connotation to refer to the complete or near complete lack of an action, characteristic, property, state, structure, item, or result, as would be appreciated by one of skill in the art.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification embodiments have been described in a way which enables a clear and concise specification to be written, but it is intended and will be appreciated that embodiments may be variously combined or separated without parting from the invention. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. A method comprising:
retrieving a frame sequence depicting an event, the frame sequence having a plurality of frames, each frame corresponding to a temporal location of the frame sequence;
extracting a feature from each frame of the plurality of frames;
combining the extracted features to generate an input matrix;
applying an event detection model to the input matrix to combine features across all temporal locations and generate an output matrix;
determining confidences and temporal displacements from the output matrix; and
determining, based on the confidences and temporal displacements, the event depicted by the frame sequence.

2. The method of claim 1, wherein the output matrix comprises a plurality of classes for each frame, and wherein the confidences and temporal displacements are determined for every frame and every class.

3. The method of claim 1, wherein determining confidences and temporal displacements further comprises performing separate convolution operations on the output matrix.

4. The method of claim 1, wherein the event detection model includes a model trunk selected from a group consisting of a 1-D U-Net and a transformer encoder (TE).

5. The method of claim 1, wherein determining the event depicted by the frame sequence based on the confidences and temporal displacements includes consolidating the confidences and temporal displacements by displacing the confidences by the temporal displacements.

6. The method of claim 1, wherein prior to applying the event detection model, a dimensionality reduction technique is applied to the input matrix.

7. The method of claim 1, further comprising training the event detection model by optimizing a confidence loss and a temporal displacement loss.

8. A non-transitory computer-readable storage medium, the computer-readable storage medium including instructions that when executed by a computer, cause the computer to:
retrieve a frame sequence depicting an event, the frame sequence having a plurality of frames, each frame corresponding to a temporal location of the frame sequence;
extract a feature from each frame of the plurality of frames;
combine the extracted features to generate an input matrix;
apply an event detection model to the input matrix to combine features across all temporal locations and generate an output matrix;
determine confidences and temporal displacements from the output matrix; and
determine, based on the confidences and temporal displacements, the event depicted by the frame sequence.

9. The computer-readable storage medium of claim 8, wherein the output matrix comprises a plurality of classes for each frame, and wherein the confidences and temporal displacements are determined for every frame and every class.

10. The computer-readable storage medium of claim 8, wherein determining confidences and temporal displacements further comprises performing separate convolution operations on the output matrix.

11. The computer-readable storage medium of claim 8, wherein the event detection model includes a model trunk selected from a group consisting of a 1-D U-Net and a transformer encoder (TE).

12. The computer-readable storage medium of claim 8, wherein determining the event depicted by the frame sequence based on the confidences and temporal displacements includes consolidating the confidences and temporal displacements by displacing the confidences by the temporal displacements.

13. The computer-readable storage medium of claim 8, wherein prior to applying the event detection model, a dimensionality reduction technique is applied to the input matrix.

14. The computer-readable storage medium of claim 8, wherein the instructions further configure the computer to train the event detection model by optimizing a confidence loss and a temporal displacement loss.

15. A computing device comprising:
a processor configured to:
retrieve a frame sequence depicting an event, the frame sequence having a plurality of frames, each frame corresponding to a temporal location of the frame sequence;
extract a feature from each frame of the plurality of frames;
combine the extracted features to generate an input matrix;
apply an event detection model to the input matrix to combine features across all temporal locations and generate an output matrix;
determine confidences and temporal displacements from the output matrix; and
determine, based on the confidences and temporal displacements, the event depicted by the frame sequence.

16. The computing device of claim 15, wherein the output matrix comprises a plurality of classes for each frame, and wherein the confidences and temporal displacements are determined for every frame and every class.

17. The computing device of claim 15, wherein determining confidences and temporal displacements further comprises performing separate convolution operations on the output matrix.

18. The computing device of claim 15, wherein the event detection model includes a model trunk selected from a group consisting of a 1-D U-Net and a transformer encoder (TE).

19. The computing device of claim 15, wherein determining the event depicted by the frame sequence based on the confidences and temporal displacements includes consolidating the confidences and temporal displacements by displacing the confidences by the temporal displacements.

20. The computing device of claim 15, wherein the processor is further configured to train the event detection model by optimizing a confidence loss and a temporal displacement loss.
